(19) United States
(12) Patent Application Publication
(10) Pub. No.: US 2007/0091363 A1
(43) Pub. Date: Apr. 26, 2007

(54) Image storage apparatus and method

(75) Inventors: Dong-hun Han, Suwon-si (KR); Chong-wan Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/582,987

(22) Filed: Oct. 19, 2006

(30) Foreign Application Priority Data
Oct. 19, 2005 (KR) 10-2005-0098666

(51) Int. Cl. G06F 3/12

(52) U.S. Cl. 358/1.15; 348/207.2

(57) ABSTRACT

An image storage apparatus and method are provided, in which a docking unit is connected with an image capturing device, a reader reads image data generated by the image capturing device from the image capturing device, a data storage unit stores the read image data, and a print controller controls an image forming device to print the stored image data by transmitting the stored image data to the image forming device. Accordingly, the image data stored in the image capturing device can be easily and quickly stored separately and printed. In addition, the image storage apparatus can perform other jobs even when printing is being performed, and various functions can be provided by supporting peripherals.

### CROSS-REFERENCE TO RELATED PATENT APPLICATION

This application claims the benefit under 35 U.S.C. § 119(a) of Korean Patent Application No. 10-2005-0098666, filed on Oct. 19, 2005, in the Korean Intellectual Property Office, the entire disclosure of which is hereby incorporated by reference.

### FIELD OF THE INVENTION

The present invention relates to an image forming system including an image capturing device, an image storage device, and an image forming device. More particularly, the present invention relates to an image storage apparatus and method for reading and storing image data stored in an image capturing device by dock-connecting the image forming apparatus to the image capturing device and for controlling an image forming device to print the stored image data by transmitting the stored image data to the image forming device.

### DESCRIPTION OF THE RELATED ART

In a conventional image forming system, an image is captured using an image capturing device and image data is printed using an image forming device.

The image capturing device is connected to the image forming device using a wired connection, such as cable, or a wireless connection such as Bluetooth or infrared. The image capturing device and the image forming device communicate with each other via firmware. In general, a user edits image data to be printed using a user interface in the image capturing device, transmits the edited image data to the image forming device, and inputs a print command into the image forming device. The image forming device, which has received the print command, receives and prints the image data.

According to the conventional image forming system, since the image capturing device transmits image data to be printed to the image forming device after the image data is stored in a storage medium included in the image capturing device, a transmission time is long, and when the transmitted image data is being printed, the image capturing device cannot perform any other job. To address these problems, a plurality of storage media can be included in the image capturing device. However, in this case, a manufacturing cost of the device increases.

In addition, the method is inconvenient since a user is required to transmit image data to be printed file by file from the image capturing device to the image forming device.

Accordingly, there is a need for an improved image storage apparatus and method for printing image data, storing image data separately, and performing other jobs while printing image data.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an image storage apparatus and method for reading and storing image data stored in an image capturing device by dock-connecting the image forming apparatus to the image capturing device and for controlling an image forming device to print the stored image data by transmitting the stored image data to the image forming device.

According to an aspect of the present invention, there is provided an image storage apparatus comprising a docking unit connected with an image capturing device; a reader for reading image data from the image capturing device; a data storage unit for storing the read image data; and a print controller for controlling an image forming device to print the stored image data by transmitting the stored image data to the image forming device.

In an exemplary implementation, the docking unit may comprise a connector directly connected to the image capturing device; and an interface unit for interfacing with the image capturing device.

In another exemplary implementation, the reader may comprise a docking sensor for sensing whether the image capturing device is docked, and a data reader for reading the image data from the docked image capturing device in response to the sensing result.

In still another exemplary implementation, the image storage apparatus may further comprise a data selector for allowing a user to select image data to be printed among image data stored in the data storage unit, wherein the print controller controls the image forming device to print the selected image data by transmitting the selected image data to the image forming device.

In a further exemplary implementation, the data selector may comprise a display unit for displaying the image data stored in the data storage unit, and an input unit for allowing the user to select image data to be printed among the displayed image data.

In an exemplary implementation, the image storage apparatus may further comprise a charger for charging the docked image capturing device by supplying power to the docked image capturing device.

In another exemplary implementation, the image storage apparatus may further comprise an image editor for editing the image data stored in the data storage unit.

In still another exemplary implementation, the image storage apparatus may further comprise a connection unit connected to the image forming device using at least one of wired, wireless, and docking methods.

In a further exemplary implementation, the connection unit can be connected to a host device.

In an exemplary implementation, the image storage apparatus may be formed in one body with the image forming device.

In another exemplary implementation, the connector can be connected to the image capturing device via a wired line.

In still another exemplary implementation, the image storage apparatus may further comprise a display panel.

In a further exemplary implementation, the image storage apparatus may further comprise a key panel

According to another aspect of exemplary embodiments of the present invention, there is provided an image storage method, in which an image capturing device is docked; image data from the image capturing device is read; and the read image data is stored.

In an exemplary implementation, the image storage method may further comprise controlling an image forming device to print the stored image data by transmitting the stored image data to the image forming device.

In another exemplary implementation, the reading may comprise sensing whether the image capturing device is docked; and reading the image data from the docked image capturing device if it is sensed that the image capturing device is docked.

In still another exemplary implementation, the controlling of the image forming device may comprise allowing a user to select image data to be printed among the stored image data, and controlling the image forming device to print the selected image data by transmitting the selected image data to the image forming device.

In a further exemplary implementation, the allowing may comprise displaying the stored image data, and allowing the user to select image data to be printed among the displayed image data.

In an exemplary implementation, the image storage method may further comprise charging the docked image capturing device by supplying power to the docked image capturing device.

In another exemplary implementation, in the controlling of the image forming device, an image storage apparatus may be connected to the image forming device using at least one of wired, wireless, and docking methods.

In still an exemplary implementation, the image storage method may further comprise editing the stored image data.

According to another aspect of exemplary embodiments of the present invention, there is provided a computer readable recording medium storing a computer readable program for executing the image storage method.

### BRIEF DESCRIPTION OF THE DRAWINGS

The above and other objects, features and advantages of certain exemplary embodiments of the present invention will be more apparent from the following description taken in conjunction with the accompanying drawings in which:

FIG. 1 is a block diagram of an image storage apparatus according to an exemplary embodiment of the present invention;

FIG. 2 is a perspective view of an image storage apparatus according to an exemplary embodiment of the present invention;

FIG. 3 is a flowchart of an image storage method according to an exemplary embodiment of the present invention;

FIG. 4 is a flowchart of a method of printing image data using an image storage apparatus, according to an exemplary embodiment of the present invention;

FIG. 5 is a flowchart of a method of printing image data stored in an image storage apparatus using an image forming device, according to an exemplary embodiment of the present invention;

FIGS. 6A through 6C are perspective views of image capturing devices connected to an image storage apparatus according to an exemplary embodiment of the present invention;

FIG. 7 is a perspective view of an image forming device connected to an image storage apparatus according to an exemplary embodiment of the present invention;

FIGS. 8A and 8B are perspective views of image capturing devices docked in an image storage apparatus according to an exemplary embodiment of the present invention;

FIG. 9 is a perspective view of an image storage apparatus docked in an image capturing device and connected to an image forming device, according to an exemplary embodiment of the present invention;

FIG. 10 is a perspective view of an image storage apparatus and an image forming device formed in one body, according to an exemplary embodiment of the present invention; and

FIGS. 11 and 12 are perspective views of image capturing devices docked in an image storage apparatus integrally configured with an image forming device, according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

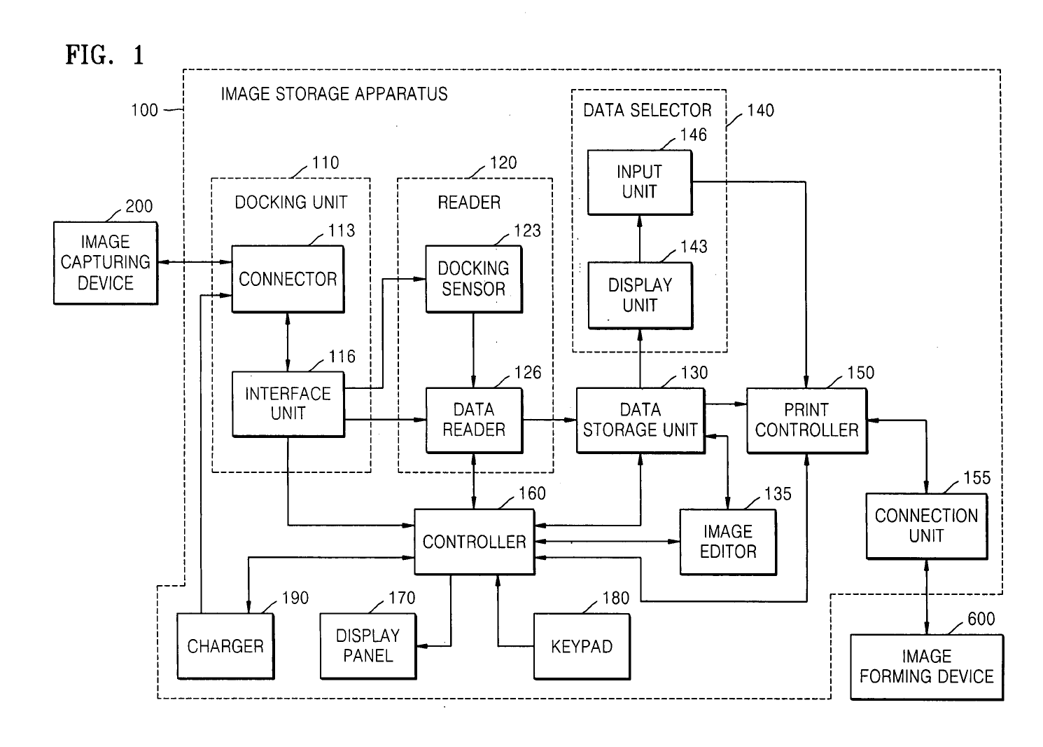

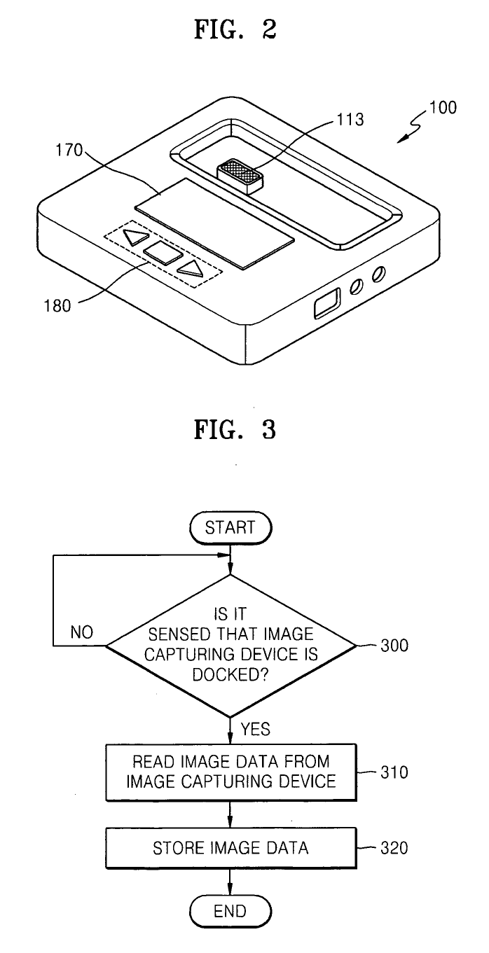

FIG. 1 is a block diagram of an image storage apparatus 100 according to an exemplary embodiment of the present invention. The image storage apparatus 100 includes a docking unit 110, a reader 120, a data storage unit 130, an image editor 135, a data selector 140, a print controller 150, a connection unit 155, a controller 160, a display panel 170, a keypad 180, and a charger 190. An operation of the image storage apparatus 100 will now be described with reference to FIG. 2.

An image capturing device 200 is docked in the docking unit 110. The docking is performed by directly connecting a connector (not shown) included in the image capturing device 200 to a connector 113 included in the image storage apparatus 100 through an electrical connection.

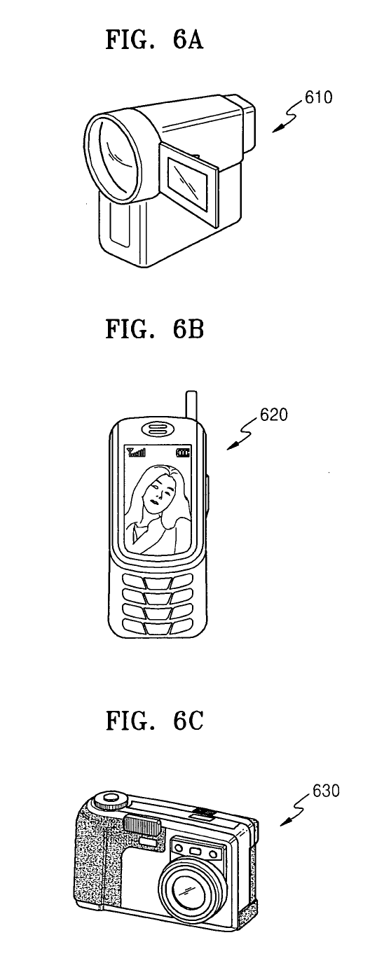

The image capturing device 200 generates image data by acquiring an image and stores the generated image data in a storage medium, such as a memory, included in the image capturing device 200. For example, the image capturing device 200 is a digital camcorder 610 as illustrated in FIG. 6A, a cellular phone 620 having a camera function as illustrated in FIG. 6B, or a digital camera 630 as illustrated in FIG. 6C. FIG. 8A is a perspective view of a digital camera 630 docked in the image storage apparatus 100 according to an exemplary embodiment of the present invention. FIG. 8B is a perspective view of a cellular phone 620 having a camera function and docked in the image storage apparatus 100 according to an exemplary embodiment of the present invention.

The docking unit 110 includes the connector 113 and an interface unit 116.

The connector 113 is connected to a connector included in the image capturing device 200 through direct docking.

The interface unit 116 interfaces the image storage apparatus 100 with the image capturing device 200 connected through the connector 113.

The reader 120 reads image data stored in the storage medium included in the image capturing device 200 via the interface unit 116.

The reader 120 includes a docking sensor 123 and a data reader 126.

The docking sensor 123 senses whether the image capturing device 200 is docked in the docking unit 110 and outputs the sensing result to the data reader 126. The docking sensor 123 senses whether the image capturing device 200 is docked in the docking unit 110 so that the interface unit 116 can interface with the docked image capturing device 200 through an electrical connection.

The data reader 126 reads the image data, which is stored in the storage medium included in the image capturing device 200 docked in the docking unit 110, via the interface unit 116 in response to the sensing result output from the docking sensor 123.

The data storage unit 130 stores the image data read by the data reader 126. The data storage unit 130 may be a bulk storage medium such as a hard disk drive or a flash memory.

The image editor 135 reads and edits the image data stored in the data storage unit 130 and stores the edited image data in the data storage unit 130. The image editor 135 displays the image data stored in the data storage unit 130 to a user through the display panel 170 and edits image data by inputting editing information from the user through the keypad 180. Alternatively, the image editor 135 edits image data by performing image processing, such as color compensation, according to a predetermined method.

The data selector 140 allows the user to select image data to be printed among the image data stored in the data storage unit 130.

The data selector 140 includes a display unit 143 and an input unit 146.

The display unit 143 displays the image data stored in the data storage unit 130. The display unit 143 displays the stored image data via a preview function so that the user can directly see the stored image data or displays a list of file names of the stored image data.

The input unit 146 allows the user to select image data to be printed among the displayed image data or input a file name of the image data to be printed.

The print controller 150 reads the image data selected or input through the input unit 146 from the data storage unit 130, transmits the read image data to an image forming device 600, and controls the image forming device 600 to print the transmitted image data. The print controller 150 can allow the user to select a trimming function of cutting and outputting a portion of the image data, an index print function of printing a plurality of photographs on a sheet of paper as a small thumbnail, additional functions such as image cutting, the number of sheets to be printed on, and the size of printing medium, and a printing environment.

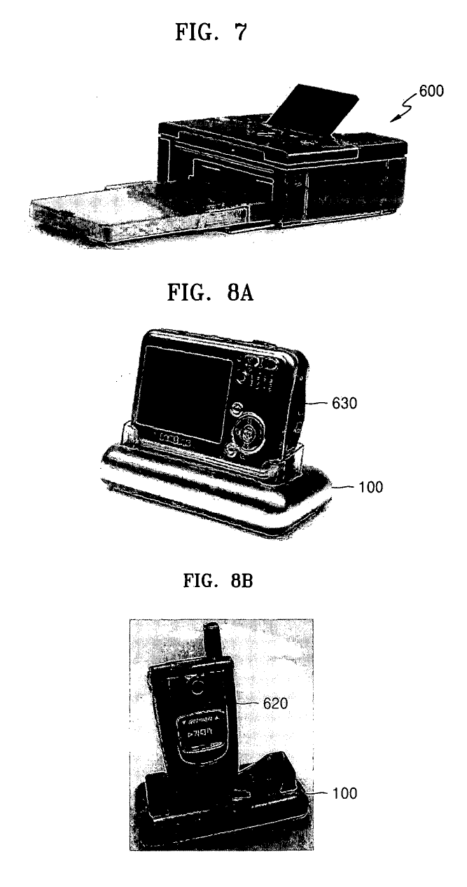

The image forming device 600 illustrated in FIG. 7, such as a printer or a multi-function product (MFP), is a device for printing image data.

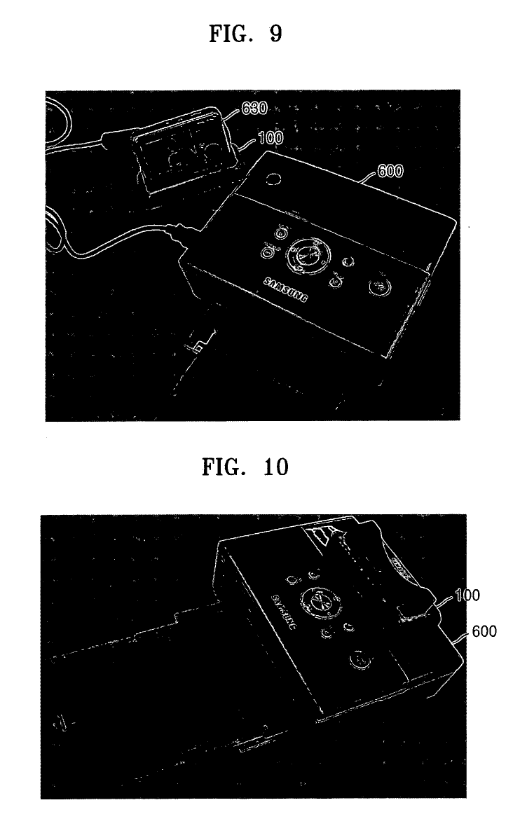

The connection unit 155 is connected to the image forming device 600 using at least one of a wired line, such as cable, a wireless line, such as Bluetooth or infrared data association (IrDA), and a docking method. FIG. 9 is a perspective view of the image storage apparatus 100 docked with a digital camera and connected to the image forming device 600 via a cable, according to an exemplary embodiment of the present invention.

The connection unit 155 also can be connected to a host device (not shown) instead of the image forming device 600. When the image storage apparatus 100 is connected to the host device using the connection unit 155, the host device can search, preview, edit, and manage the image data stored in the image storage apparatus 100, receive image data from the image storage apparatus 100, and store the received image data in a storage medium included in the host device.

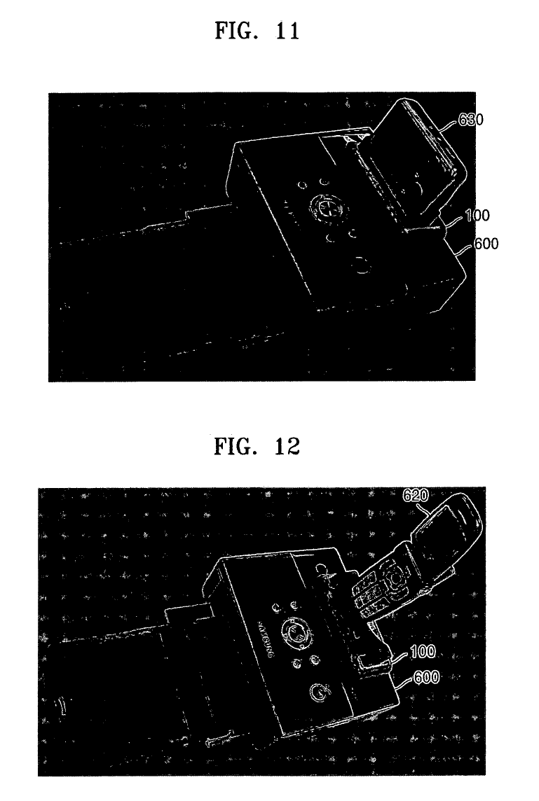

Instead of the method of connecting the image storage apparatus 100 to the image forming device 600 using the connection unit 155, the image storage apparatus 100 can be formed in one body with the image forming device 600 as illustrated in FIG. 10. FIG. 11 is a perspective view of a digital camera 630 docked in the image storage apparatus 100 formed in one body with the image forming device 600, according to an exemplary embodiment of the present invention. FIG. 12 is a perspective view of a cellular phone docked in the image storage apparatus 100 formed in one body with the image forming device 600, according to an exemplary embodiment of the present invention.

The controller 160 generally controls an operation of the image storage apparatus 100.

The display panel 170 displays information regarding an operation and control of the image storage apparatus 100 and the image data stored in the data storage unit 130. However, a display device included in the image capturing device 200 or the image forming device 600 can be replaced with the display panel of the image storage apparatus 100.

The keypad 180 is used to control an operation of the image storage apparatus 100, input information regarding the image storage apparatus 100, select image data displayed on the display panel 170, and input information to edit image data.

The charger 190 charges the image capturing device 200 by supplying power using power supplied to the image storage apparatus 100 from the image forming device 600 or an external power supply.

FIG. 3 is a flowchart of an image storage method according to an exemplary embodiment of the present invention.

Referring to FIG. 3, in step 300, an image storage apparatus senses whether an image capturing device is docked in a connector of the image storage apparatus.

If it is sensed that the image capturing device is docked, in step 310, the image storage apparatus reads image data from a storage medium included in the image capturing device by interfacing with the image capturing device using firmware.

In step 320, the image storage apparatus stores the read image data in a bulk storage unit included in the image storage apparatus, such as a hard disk drive or a flash memory.

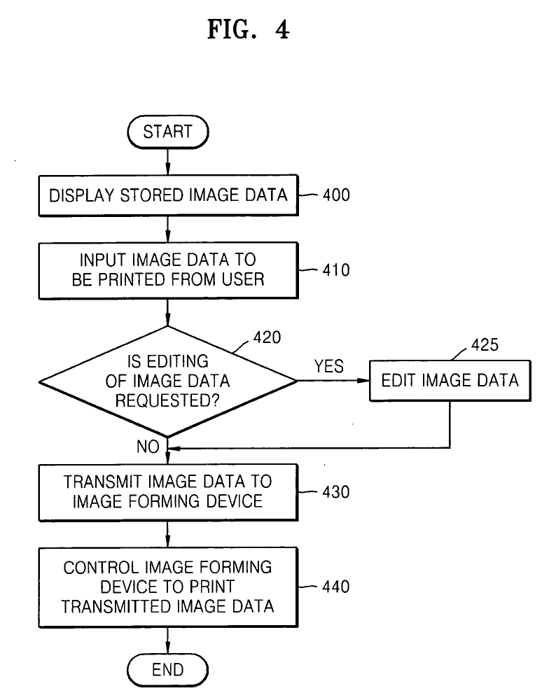

FIG. 4 is a flowchart of a method of printing image data using an image storage apparatus, according to an exemplary embodiment of the present invention.

Referring to FIG. 4, in step 400, the image storage apparatus directly displays image data stored in a storage medium included in the image storage apparatus so that a user can see the stored image data using a user interface or displays a list by listing file names of the stored image data.

In step 410, the user inputs image data to be printed among the displayed image data into the image storage apparatus using an input device such as a keypad.

In step 420, the user inputs into the image storage apparatus whether the input image data is edited.

If the user requests that the input image data be edited, in step 425, the image storage apparatus edits the input image data. Here, the image storage apparatus displays the image data stored in the image storage apparatus to the user using a display unit and edits image data by inputting editing information from the user using the input device. Alternatively, the image storage apparatus edits image data by performing image processing, such as color compensation, according to a predetermined method.

If the user does not request that the input image data be edited, or after step 425, the image storage apparatus transmits the input image data to an image forming device in step 430.

In step 440, the image storage apparatus controls the image forming device to print the transmitted image data.

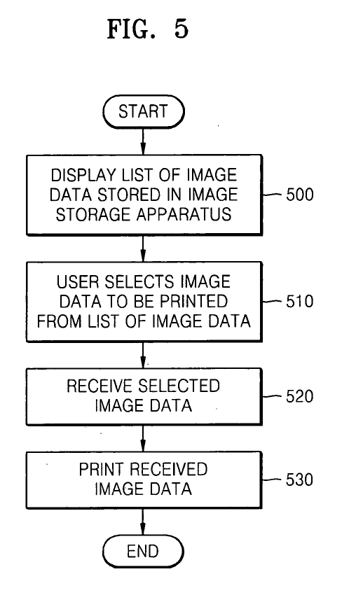

FIG. 5 is a flowchart of a method of printing image data stored in an image storage apparatus using an image forming device, according to an exemplary embodiment of the present invention.

Referring to FIG. 5, in step 500, the image forming device receives a list of image data stored in a storage medium included in the image storage apparatus from the image storage apparatus and displays the list.

In step 510, a user selects image data to be printed from the displayed list.

In step 520, the image forming device receives the selected image data from the image storage apparatus.

In step 530, the image forming device prints the received image data.

The invention can also be embodied as computer (including every device having an information processing function) readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

As described above, in an image storage apparatus and method according to exemplary embodiments of the present invention, image data stored in an image capturing device is read and stored by dock-connecting the image forming apparatus to the image capturing device, and an image forming device is controlled to print the stored image data by transmitting the stored image data to the image forming device.

Thus, the image data stored in the image capturing device can be easily and quickly stored separately and printed. In addition, the image storage apparatus can perform other jobs even when printing is being performed. Furthermore, besides a simple image data storage function, various functions can be provided by supporting peripherals.

While the present invention has been particularly shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. An image storage apparatus connected to an image capturing device generating image data by acquiring an image and an image forming device printing image data, the apparatus comprising:
a docking unit connected with the image capturing device;
a reader for reading the generated image data from the image capturing device;
a data storage unit for storing the read image data; and
a print controller for controlling the image forming device to print the stored image data by transmitting the stored image data to the image forming device.

2. The apparatus of claim 1, wherein the docking unit comprises:
a connector directly connected to the image capturing device; and
an interface unit for interfacing with the connected image capturing device.

3. The apparatus of claim 1, wherein the reader comprises:
a docking sensor for sensing whether the image capturing device is docked; and
a data reader for reading the image data from the docked image capturing device in response to the sensing result.

4. The apparatus of claim 1, further comprising a data selector for allowing a user to select image data to be printed among image data stored in the data storage unit,
wherein the print controller controls the image forming device to print the selected image data by transmitting the selected image data to the image forming device.

5. The apparatus of claim 4, wherein the data selector comprises:
a display unit for displaying the image data stored in the data storage unit; and
an input unit for allowing an image data selection to be printed among the displayed image data.

6. The apparatus of claim 1, further comprising a charger for charging the docked image capturing device by supplying power to the docked image capturing device.

7. The apparatus of claim 1, further comprising an image editor for editing the image data stored in the data storage unit.

8. The apparatus of claim 1, further comprising a connection unit connected to the image forming device using at least one of wired, wireless, and docking methods.

9. The apparatus of claim 8, wherein the connection unit is connected to a host device.

10. The apparatus of claim 1, wherein the image storage apparatus is formed in one body with the image forming device.

11. The apparatus of claim 2, wherein the connector can be connected to the image capturing device via a wired line.

12. The apparatus of claim 1, further comprising a display panel for displaying information regarding an operation and control of the image storage apparatus.

13. The apparatus of claim 1, further comprising a key panel for controlling an operation and input information of the image storage apparatus, selecting image data displaying on a display panel, and inputting information to edit image data.

14. A method of storing images for an image storage apparatus connected to an image capturing device generating image data by acquiring an image and an image forming device printing image data, the method comprising:
docking the image capturing device;
reading the generated image data from the image capturing device; and
storing the read image data.

15. The method of claim 14, further comprising controlling the image forming device to print the stored image data by transmitting the stored image data to the image forming device.

16. The method of claim 14, wherein the reading comprises:
sensing whether the image capturing device is docked; and
reading the image data from the docked image capturing device if it is sensed that the image capturing device is docked.

17. The method of claim 15, wherein the controlling comprises:
allowing a user to select image data to be printed among the stored image data; and
controlling the image forming device to print the selected image data by transmitting the selected image data to the image forming device.

18. The method of claim 17, wherein the allowing comprises:
displaying the stored image data; and
allowing the user to select image data to be printed among the displayed image data.

19. The method of claim 14, further comprising charging the docked image capturing device by supplying power to the docked image capturing device.

20. The method of claim 15, wherein, in the controlling, the image storage apparatus is connected to the image forming device using one of wired, wireless, and docking methods.

21. The method of claim 14, further comprising reading and editing the stored image data.

22. A computer readable recording medium storing a computer readable program for executing a method for storing images for an image storage apparatus connected to an image capturing device generating image data by acquiring an image and an image forming device printing image data, the method comprising:
docking the image capturing device;
reading the generated image data from the image capturing device;
storing the read image data
controlling the image forming device to print the stored image data by transmitting the stored image data to the image forming device
charging the docked image capturing device by supplying power to the docked image capturing device; and
editing the stored image data.

23. The apparatus of claim 7, wherein the image editor displays the image data stored in the data storage unit and edits image data by inputting editing information.

24. The apparatus of claim 1, wherein the print controller comprises:
a selection for selecting a trimming function of cutting and outputting a portion of the image data;
an index print function of printing a plurality of photographs on a sheet of paper as a small thumbnail;
an image cutting function;
a selection for selecting a number of sheets of paper to print; and
a selection for selecting a size of printing.

25. The apparatus of claim 1, wherein the image capturing device comprises a digital camcorder.

26. The apparatus of claim 1, wherein the image capturing device comprises a cellular phone comprising a camera function.

27. The apparatus of claim 1, wherein the image capturing device comprises a digital camera.

28. The method of claim 14, wherein the image capturing device comprises a digital camcorder.

29. The method of claim 14, wherein the image capturing device comprises a cellular phone comprising a camera function.

30. The method of claim 14, wherein the image capturing device comprises a digital camera.
